(19) United States
(12) Patent Application Publication
(10) Pub. No.: US 2024/0286137 A1
(43) Pub. Date: Aug. 29, 2024

(54) MICROTITER PLATE

(71) Applicants: InnoME GmbH, Espelkamp (DE); Karlsruher Institut für Technologie, Karlsruhe (DE)

(72) Inventors: Jürgen Hubbuch, Pfinztal (DE); Carsten Radtke, Karlsruhe (DE); Marie-Therese Schermeyer, Berlin (DE); Martin Woywod, München (DE); Daniel Baasner, Minden (DE); Jannik Jungmann, Löhne (DE)

(73) Assignees: InnoME GmbH, Espelkamp (DE); Karlsruher Institut für Technologie, Karlsruhe (DE)

(21) Appl. No.: 18/656,781

(22) Filed: May 7, 2024

Related U.S. Application Data
(63) Continuation-in-part of application No. 16/864,297, filed on May 1, 2020.

(30) Foreign Application Priority Data
May 3, 2019 (DE) 102019003135.0

(51) Int. Cl. B01L 3/00

(52) U.S. Cl. CPC B01L 3/5085; B01L 2200/0684

(57) ABSTRACT

A microtiter plate, preferably in the form of an injection-molded part composed of plastic, having at least one first and one second fluid chamber, which are designed in particular as measurement chambers and are connected to one another by a fluid channel which, in cross section, is closed or enclosed on all sides or all the way round, and the fluid channel is assigned a bubble trap, by way of which the movement of air or gas bubbles moving along a top wall portion or a top wall of the fluid channel, the top wall portion or the top wall closing or enclosing the fluid channel upwardly, in particular from one fluid chamber to another fluid chamber, can be stopped.

### CROSS REFERENCE TO RELATED APPLICATIONS

This application is a continuation-in-part of U.S. patent application Ser. No. 16/864,297 having a filing date of 1 May 2020, which claims priority on and the benefit of German Patent Application No. 10 2019 003 135.0 having a filing date of 3 May 2019.

### BACKGROUND OF THE INVENTION

### Technical Field

The present invention relates to a microtiter plate comprising multiple measurement chamber systems, preferably in the form of an injection-molded part composed of plastic, which are arranged so as to be distributed over the microtiter plate in grid form. Each measurement chamber system has at least one first and one second fluid chamber, each of which is designed in particular as a measurement chamber. Neighboring fluid chambers are connected to another via a fluid channel which, in cross section, is closed on all sides or all the way round by a wall or walls.

The present invention also relates to a microtiter plate comprising multiple measurement chamber systems, preferably in the form of an injection-molded part composed of plastic, having multiple measurement chamber systems, which are arranged so as to be distributed over the microtiter plate in grid form. Each of the fluid channels decreases in height and increases in width in a fluid flow direction from the first fluid chamber to the second fluid chamber in at least one section thereof, preferably in a section which extends over the entire length of the fluid channel. Similarly, in embodiments with more than two fluid chambers, each of the fluid channels connecting the second fluid chamber to a third fluid chamber, and a third fluid chamber to a fourth fluid chamber, etcetera, also decreases in height and increases in width in the fluid flow direction.

The present invention also relates to a microtiter plate comprising multiple measurement chamber systems, preferably in the form of an injection-molded part composed of plastic, having multiple measurement chamber systems, which are arranged so as to be distributed over the microtiter plate in grid form, and having multiple fluid chambers for samples for testing. The first and second fluid chambers are each upwardly closed by a top wall, wherein the inner height of the first fluid chamber is larger than the inner height of the second fluid chamber. In embodiments having more than two fluid chambers, the inner height of each successive fluid chamber in the direction of flow of the sample fluid is smaller than the preceding fluid chamber.

### Prior Art

Microtiter plates having multiple fluid chambers for samples for testing can be used not only but inter alia for determining the concentration of particular molecules in a liquid sample by means of photometric measurement methods. Here, microtiter plates having multiple measurement chamber systems which are arranged so as to be distributed over the microtiter plate in grid form, for which each measurement chamber system has fluid chambers of different height that are connected to one another by a channel structure, with the result that detection light which is in each case emitted through the fluid chambers passes through different sample path lengths of one and the same sample, are also known. Using the Lambert-Beer law, the concentration of the molecular concentration contained in the sample can then be inferred by analysis of the absorption values which absorption values differ owing to the different path lengths.

### BRIEF SUMMARY OF THE INVENTION

It is an object of the present invention to further develop the microtiter plates mentioned in the introduction.

Said object is achieved by a microtiter plate, preferably in the form of an injection-molded part composed of plastic, having at least one first and one second fluid chamber, which are designed in particular as measurement chambers and are connected to another by a fluid channel which, in cross section, is closed on all sides or all the way round by a wall or walls, wherein the fluid channel is assigned a bubble trap, by way of which the movement of air or gas bubbles which move along a top wall, closing or enclosing the fluid channel upwardly, of the fluid channel, the top wall extending in particular from the first to the second fluid chamber, can be stopped.

Said object also is achieved by a microtiter plate, preferably in the form of an injection-molded part composed of plastic, having multiple measurement chamber systems which are arranged so as to be distributed over the microtiter plate in grid form. Each measurement chamber system has at least one first and one second fluid chamber, each of which is designed in particular as a measurement chamber. Neighboring fluid chambers are connected to one another via a fluid channel which, in cross section, is closed all the way round by a wall or walls. Each of the fluid channels decreases in height and increases in width in a fluid flow direction from the first fluid chamber to the second fluid chamber in at least one section thereof, preferably in a section which extends over the entire length of the fluid channel.

The first and second fluid chambers, and any additional fluid chamber in embodiments with more than two fluid chambers, are each upwardly closed or enclosed by a top wall, and wherein the inner height of the first fluid chamber is larger than the inner height of the second fluid chamber, wherein the width of the fluid channel in the at least one section increases and the height of the fluid channel decreases from the first to the second fluid chamber. In embodiments having more than two fluid chambers, the inner height of each successive fluid chamber in the direction of flow of the sample fluid is smaller than the preceding fluid chamber. In embodiments with more than two fluid chambers, each of the fluid channels connecting the second fluid chamber to a third fluid chamber, and a third fluid chamber to a fourth fluid chamber, etcetera, also decreases in height and increases in width in the fluid flow direction.

The wall may include a bottom wall portion, side wall portions, and a top wall portion, or the wall may include a bottom wall, side walls, and a top wall. The actual structure of the wall, be it tubular, arched, or consisting of separate walls, is secondary, the primary requirement being that the wall or walls close or enclose the entire fluid channel between each of the fluid chambers. The bottom wall portion or the bottom wall of the fluid channels preferably is flat. The side wall portions or the side walls of the fluid channels may be generally lateral and generally vertical relative to the bottom wall portion or bottom walls and extend upwardly form the bottom wall portion or the bottom wall. The top wall portion or the top wall of the fluid channels may be generally flat and extend between the side wall portions or the side wall. Alternatively, the side wall portions or side wall and the top wall portion or top wall may be a single arched or arch-like structure. As mentioned previously, the height or distance between the top wall portion or the top wall and the bottom wall portion or the bottom wall decreases relative to each other in the direction of flow of the sample fluid.

The microtiter plate comprises a base plate underneath and supporting the multiple measurement system chambers to create a unitary whole. Portions of an upper surface of the base plate also serve as the bottom wall portion or the bottom wall of the fluid channels and the fluid chambers.

A microtiter plate according to the invention accordingly has at least one first and one second fluid chamber, which are connected to another by a fluid channel which, in cross section, is closed or enclosed on all sides or all the way round by a wall or walls, wherein the fluid channel is assigned a bubble trap, by way of which the movement of air or gas bubbles which move along the top wall portion or the top wall of the fluid channel can be stopped, in particular as the fluid moves from the first to the second fluid chamber.

In this way, it is achieved for example, in particular if one or both (or all) fluid chambers are measurement chambers into which it is possible to introduce samples for measuring properties thereof, that any air bubbles interfering with such measurements, which, during the use of the microtiter plate, can outgas from the fluid or the sample and are situated in the fluid channel, are prevented from migrating into one of the two (or any) of the fluid chambers and, there, affecting the measurement. It would thus be possible, for example, for air bubbles which outgas in one fluid chamber and then migrate in the direction of another fluid chamber via a fluid channel to be stopped from moving further at the bubble trap, with the result that said air bubbles do not interfere with in particular optical, such as for example photometric, measurements in the second fluid chamber.

Within the scope of the present application, measurement chambers are accordingly in particular fluid chambers which are provided such that measurements can be carried out for fluid situated therein or for sample liquid situated therein.

A microtiter plate according to the invention also has, as an extension of the above microtiter plate, multiple measurement chamber systems which are arranged so as to be distributed over the microtiter plate in grid form, of which each has in each case at least one such first and second fluid chamber, each of such fluid chambers being preferably designed as a measurement chamber, and each of such fluid chambers being connected to one another via a fluid channel which, in cross section, is closed or enclosed all the way round, said fluid channel decreasing in terms of its inner height in a fluid flow direction from the first fluid chamber to the second fluid chamber in at least one section, preferably in a section which extends over the entire length of the fluid channel. Here, the first and second fluid chambers are each upwardly closed by a top wall portion or a top wall, wherein the inner height of the first fluid chamber is greater than the inner height of the second fluid chamber. The microtiter plate is characterized in that the width of the fluid channel widens in terms of inner width in this section or preferably over the entire length of the fluid channel in the fluid flow direction from the first to the second fluid chamber.

In this way, according to the invention, by reduction of pressure differences, optimization of the flow between the two fluid chambers is achieved such that, when the measurement chamber system is filled, the formation of turbulent flows, which promote the outgassing of air bubbles, is prevented or limited.

The features described herein of a microtiter plate according to the invention may preferably be combined with one another. In particular, all the features taught herein may be combined both with a microtiter plate as described herein and with a microtiter plate having multiple measurement chamber systems. It may thus be provided for example that the aforementioned bubble trap is assigned to the fluid channel of each measurement chamber system of the multi-titer microtiter plate having multiple measurement chamber systems that connects the first and second fluid chambers.

As far as the bubble trap already mentioned is concerned, the top wall portion or the top wall of the fluid channel may comprise a recess in the top wall of the fluid channel, which recess is open toward the fluid channel interior and can then be entered by an air or gas bubble and, there, trapped or held. Preferably, the bubble trap prevents air or gas bubbles in the fluid channel from entering a fluid chamber.

Preferably, as seen in cross section, such a recess, in the region of the top wall in which it is arranged, can extend over the entire width or breadth of the top wall.

As an alternative to a recess in the top wall, the bubble trap may also comprise a downwardly directed projection or web, from or of the top wall portion or the top wall, which is connected to the top wall of the fluid channel and is in particular integrally formed on the top wall. This projection or web is preferably of such a size that air bubbles which move along the top wall portion or the top wall of the fluid channel are held between the projection or web and the top wall or are stopped by the projection or web. Preferably, the bubble trap prevents air or gas bubbles in the fluid channel from entering a fluid chamber.

Here, the projection or web preferably covers—in relation to the cross section of the fluid channel—a sub-cross-sectional surface of the entire fluid channel cross-sectional surface that is arranged in the upper region of the channel, namely, proximal to the top wall portion or the top wall.

In particular, the projection or web can sealingly cover the sub-cross-sectional surface to the top wall portion or the top wall of the fluid channel and to lateral walls of the channel, namely the side wall portions or the side walls, so that, to the sides of and above the projection or web, no air or gas bubbles are able to move past said projection or web.

As far as the fluid channel is concerned, the height of the fluid channel decreases in the fluid flow direction from the first to the second fluid chamber in the at least one section such that, in said section, the inner side (facing the interior of the channel) of the top wall portion or the top wall of said fluid channel extends so as to be inclined downwardly with respect to the horizontal in the fluid flow direction.

Where reference is made in the present application to “horizontal” and “upward” or “upwardly” or “downward” or “downwardly”, this information relates to an intended use of the microtiter plate in which the microtiter plate is positioned with a horizontal orientation on a horizontal support surface, such as for example on a table, etc. In this positioning, the bottom of the base plate of the microtiter plate is positioned with a horizontal orientation on a horizontal support surface, such as for example on a table.

Preferably, the or each fluid channel may be connected at one end via a connection opening with a relatively larger height and smaller width to the first fluid chamber and at another end via a connection opening with a relatively smaller height and larger width to the second fluid chamber.

Here, the inner height of the first fluid chamber may correspond to the height of the connection opening connecting the first fluid chamber to the fluid channel, and the inner height of the second fluid chamber may correspond to the height of the connection opening connecting the second fluid chamber to the fluid channel.

In a further particularly preferred configuration of the invention, the first and second fluid chambers are each upwardly closed or enclosed by a or their top wall portion or top wall, wherein the inner height of the first fluid chamber is greater than the inner height of the second fluid chamber, in particular such that the inner height of the first fluid chamber corresponds to the height of the connection opening connecting the first fluid chamber to the fluid channel and the inner height of the second fluid chamber corresponds to the height of the connection opening connecting the second fluid chamber to the fluid channel.

As far as the recess of the bubble trap in the top wall portion or the top wall of the fluid channel is concerned, the height of the recess at the highest point of the recess in the top wall portion or the top wall may preferably be greater than the maximum height of the inner side of the top wall portion or the top wall along the fluid channel.

Alternatively or additionally, the height of the recess at the highest point of the recess in the top wall portion or the top wall may be greater than the height of the connection opening between the first fluid chamber and the fluid channel with relatively great height, and also may be greater than the height of the connection opening which connects the fluid channel to the second fluid chamber.

Furthermore alternatively or additionally, the height of the recess at the highest point thereof may be greater than the inner height of the second fluid chamber.

Preferably, the microtiter plate, in particular each measurement system, also has, in addition to the first and second fluid chambers, at least one upwardly open inlet (fluid) chamber, which is connected to the first fluid chamber by means of a further (separate) fluid channel, the further (separate) fluid channel in particular, in cross section, being closed or enclosed on all sides, and via which sample fluid is able to be supplied to each measurement system.

Furthermore preferably, the microtiter plate, in particular each measurement chamber system, also has, in addition to the first and second fluid chambers, at least one upwardly open outlet (fluid) chamber, which is connected to the second (or final) fluid chamber by a further (separate) fluid channel, the further (separate) fluid channel, in cross section, being closed or enclosed on all sides, and via which sample fluid is able to be removed from the measurement chamber system. Moreover, when the measurement chamber system is filled, air which is situated in the measurement chamber system can escape through said outlet chamber.

Furthermore preferably, the microtiter plate, in particular each measurement system, has at least one third fluid chamber, which is designed in particular as a measurement chamber and is upwardly closed or enclosed by a top wall portion or a top wall, wherein the inner height of the third fluid chamber is smaller than the inner height of the second fluid chamber, and wherein the third fluid chamber is connected to the second fluid chamber by a further (separate) fluid channel, which, in cross section, is closed or enclosed on all sides and which decreases in height and widens in width or breadth in a fluid flow direction from the second fluid chamber to the third fluid chamber in at least one section, preferably in a section which extends over the entire length of the fluid channel.

Here, the width or breadth of the further fluid channel, which widens in the at least one section, may—in a manner similar to that of the fluid channel connecting the first and second fluid chambers—widen in said section from the second to the third fluid chamber.

Insofar as provision is made of an inlet chamber in this embodiment, the inlet chamber would preferably still be connected to the first fluid chamber by a fluid channel and the outlet chamber would preferably be connected to the third fluid chamber and not to the second fluid chamber.

As far as the top wall portions or the top walls of the first and second fluid chambers and, if appropriate, of the third fluid chamber are concerned, these may preferably each be adjacent to the surroundings of the microtiter plate, consist of material transparent to light and each have the same thickness. For example, the top wall portions or the top walls of the fluid chambers may preferably each be adjacent to but separated from the surroundings (the ambient or outside), namely, between the interiors of the fluid chambers and the surroundings, and consist of material transparent to light and each have the same thickness.

Furthermore, the top wall portions or the top walls of the first, of the second and, if appropriate, of the third fluid chamber (and preferably any additional fluid chambers in further embodiments) may preferably have an inner side which in each case faces the interior of the respective fluid chamber, and an outer side which is adjacent to the outer surroundings of the microtiter plate and extends in particular parallel to the inner side, wherein the in each case equal thickness of the top wall relates to the spacing of the outer side to the inner side or corresponds thereto. Preferably the top wall portions or the top walls of each of the fluid chambers is of equal thickness.

Expediently, the microtiter plate has a base plate (oriented in a horizontal plane when the microtiter plate is used as intended), on which the first, second and, if appropriate, the third fluid chamber (and preferably any additional fluid chambers), the fluid channel(s) connecting the fluid chambers, and if appropriate the inlet chamber and if appropriate the outlet chamber are arranged next to one another in a common (horizontal) plane, preferably in a generally linear sequence.

Preferably, the base plate in each case forms the respective bottom wall of the first, second and, if appropriate, third fluid chamber (and preferably any additional fluid chambers), of the fluid channel(s) connecting the fluid chambers, and if appropriate of the inlet chamber and if appropriate of the outlet chamber.

The inner side, facing the interior of the respective fluid chamber, and/or the outer side, adjacent to the outer surroundings of the microtiter plate, of the top wall portions or the top wall of the first, the second and, if appropriate, the third fluid chamber (and preferably any additional fluid chamber) may in this case extend parallel to the base plate of the microtiter plate or parallel to the outer side (bottom), adjacent to the surroundings, of the base plate.

### BRIEF DESCRIPTION OF THE DRAWINGS

Further features of the present invention will emerge from the appended patent claims, from the following description of preferred exemplary embodiments and from the appended drawings.

In the drawings:

FIG. 1 shows an oblique view of a microtiter plate according to the invention with a multiplicity of measurement systems arranged in grid form;

FIG. 2 shows a plan view of a single measurement system as per FIG. 1;

FIG. 3 shows a cross section along the section line B-B in FIG. 2;

FIG. 4 shows a cross section along the section line A-A in FIG. 2; and

FIG. 5 shows an alternative cross section along the section line B-B in FIG. 2, replacing a recess 25 with a projection or web 27.

FIG. 6 shows a cross section along line C-C of FIG. 2 and represents an elongated straightened side view of an exemplary embodiment of a single measurement system.

FIG. 7 shows a cross section along line F-F of FIG. 3 showing a structure of a bubble trap in the form of a projection or web.

FIG. 8 shows a cross section along line G-G of FIG. 5 showing a structure of a bubble trap in the form of a recess.

FIG. 9 shows an alternate view of FIG. 4 showing an operation of a bubble trap in the form of a recess.

FIG. 10 shows an alternate view of FIG. 5 showing an operation of a bubble trap in the form of a projection or web.

### DETAILED DESCRIPTION OF PREFERRED EMBODIMENTS

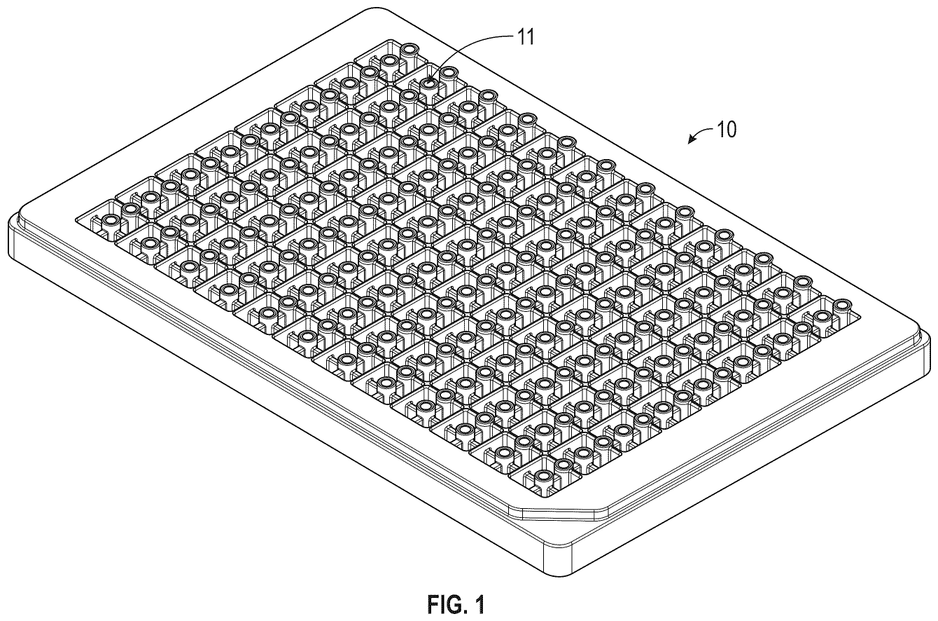

FIG. 1 shows a microtiter plate 10, which is preferably manufactured as an injection-molded part from plastic.

The microtiter plate 10 has a multiplicity of measurement systems 11. The measurement systems 11 are arranged so as to be distributed over the microtiter plate 10 in grid form. As is known in the prior art, such microtiter plates 10, in terms of their dimensions and their number of measurement systems 11, are generally standardized so as to allow simple incorporation thereof into existing automated measurement processes or measurement apparatuses.

In the present case, 8 x 12 measurement systems 11 are present in FIG. 1. However, it goes without saying that various other arrangements in grid form, also having more or fewer measurement systems, are possible.

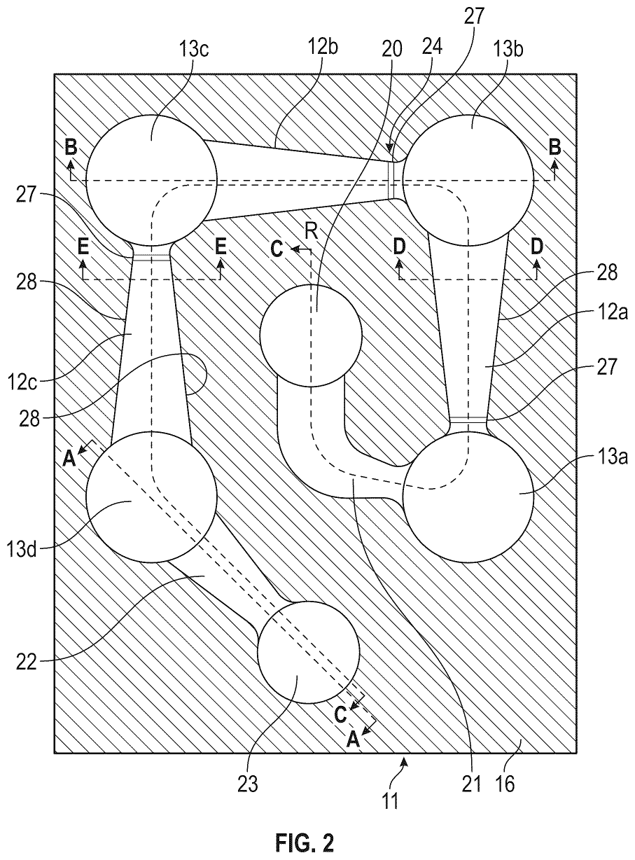

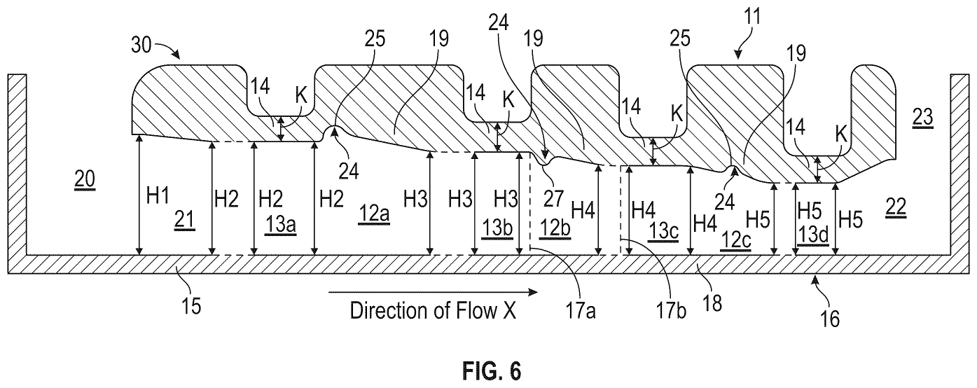

Referring now to FIG. 2 with reference to FIG. 6, each of the measurement chamber systems 11 has multiple, in the present case four (although there may be more or fewer), fluid chambers 13, designated herein for ease of reference as first fluid chamber 13a, second fluid chamber 13b, third fluid chamber 13c, and fourth fluid chamber 13d, which are connected to one another via fluid channels 12, designated herein for ease of reference as first fluid channel 12a, second fluid channel 12b, and third fluid channel 12c. Each of the fluid chambers 13 and fluid channels 12 are closed or enclosed on all sides in cross section via a wall, and together the combination of at least two fluid chambers 13 and one fluid channel 12 are designed as measurement chambers. As mentioned previously, the instant specification discloses the invention as having four fluid chambers 13 and three fluid channels 12. Other contemplated embodiments of the invention may have as few as two fluid chambers 13 and one fluid channel 12, three fluid chambers 13 and two fluid channels 12, or more than four fluid chambers 13 and more than three fluid channels, as long as the general serial structure of FIGS. 2 and 6 is maintained.

In the present case, as shown in FIG. 2 and later in FIG. 6, the fluid chambers 13 are, by way of the fluid channels 12, arranged in the manner of a “series connection” in series one behind the other or successively. For ease of reference herein, first fluid chamber, 13a, second fluid chamber 13b, third fluid chamber 13c, and fourth fluid chamber 13d will be referred to collectively as fluid chambers 13 or fluid chambers 13a-13d. Similarly, for ease of reference herein, first fluid channel, 12a, second fluid channel 12b, and third fluid channel 12c will be referred to collectively as fluid channels 12 or fluid channels 12a-12c.

Accordingly, in each case the first fluid chamber 13a, which is first in the series, is connected only to the second fluid chamber 13b, which is the next one in the series, via fluid channel 12a, and the last fluid chamber 13d, which is last in the series, is connected only to the third fluid chamber 13c, which is the preceding one in the series, via fluid channel 12c. The second fluid chamber 13b is connected to the third fluid chamber 13c via the second fluid channel 12b. FIG. 2 shows this serial arrangement in the preferred “curled” structure, while FIG. 6 shows this serial arrangement in an “uncurled” structure for illustrative purposes.

Thus, the second fluid chamber 13b and the third fluid chamber 13c, respectively, which are the middle ones in the illustrative series shown in FIGS. 2 and 6, are connected via the first fluid channel 12a or the second fluid channel 12b or the third fluid channel 12c firstly to one another and secondly to, in each case, the preceding first fluid chamber 13a or the succeeding fourth fluid chamber 13d.

Each of the fluid chambers 13a-13d is upwardly closed and downwardly closed, specifically by in each case one top wall 14 and one bottom wall 15, respectively.

The inner heights H of the fluid chambers 13a-13d, specifically in the present case the spacing between the inner bottom side of the top wall 14 facing the interior of the respective fluid chamber 13a-13d and the inner top side of the bottom wall 15 facing the interior of the respective fluid chamber 13a-13d in the series of the successive fluid chambers 13a-13d, starting with the first fluid chamber 13a, via the second fluid chamber 13b and the third fluid chamber 13c, to the fourth fluid chamber 13d, become smaller in each case. For example, the inner height H2 of the first fluid chamber 13a is greater than the inner height H3 of the second fluid chamber 13b, the inner height H3 of the second fluid chamber 13b is greater than the inner height H4 of the third fluid chamber 13c, and the inner height H4 of the third fluid chamber 13c is greater than the inner height H5 of the fourth fluid chamber 13d. Preferably, the width or diameter of each of the fluid chambers are the same as each other, although in certain embodiments, the widths of various of the fluid chambers 13 can be different from each other.

Accordingly, for each pair of neighboring, connected fluid chambers 13a-13d connected to one another via a corresponding fluid channel 12a-12c, it is the case that the inner height of the fluid chamber 13a-13d which is in each case the preceding one in the series is greater than the inner height of the fluid chamber 13a-13d which is in each case the next one in the series. Specifically, as mentioned above, the height H2 of the first fluid chamber 13a is greater than the height H3 of the second fluid chamber 13b, the height H3 of the second fluid chamber 13b is greater than the height H4 of the third fluid chamber 13c, and the height H4 of the third fluid chamber 13c is greater than the height H5 of the fourth fluid chamber 13d.

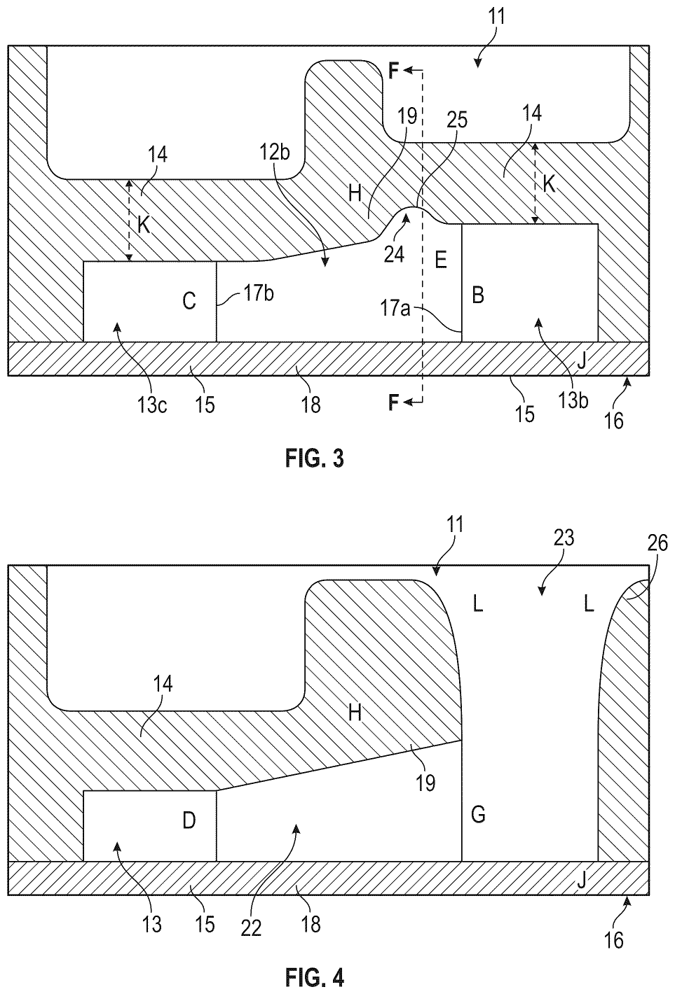

The bottom wall 15 of each fluid chamber 13a-13d is in the present case in each case formed by a common base plate 16 or a corresponding wall of the microtiter plate 10. As can be seen best in FIGS. 3-10, the base plate 16 of the microtiter plate 10 forms a plate bottom wall for the entire microtiter plate 10, with a top surface of the base plate 16 forming the interior bottom wall 15 of the fluid chambers 13 and the bottom wall portions or bottom walls 18 of the fluid channels 12.

The top walls 14 of the individual fluid chambers 13a-13d are formed as different areas of a common plate top wall 30 of the microtiter plate 10 and are correspondingly connected to one another integrally so as to merge into one another.

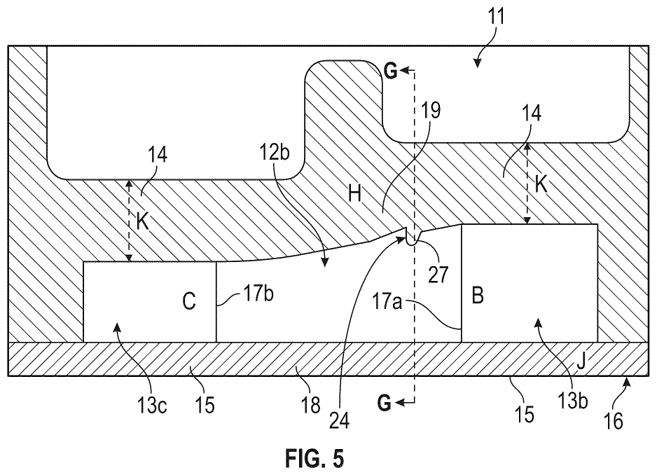

Referring now to FIGS. 3-5, for each pair of neighboring, connected fluid chambers 13a, 13b; 13b, 13c; 13c, 13d it is furthermore the case that the fluid channel 12a, 12b or 12c in each case connecting the respective pair of neighboring, connected fluid chambers 13a, 13b; 13b, 13c; 13c, 13d is connected at one end via a first connection opening 17a with a relatively greater height to the fluid chamber 13a-13d which is the preceding one in the series and at its other end via a second connection opening 17b with a relatively smaller height to the fluid chamber 13a-13d which is in each case the next one in the series. More specifically, the greater height of the first connection opening 17a is relative to the smaller height of the second connection opening 17b. In FIGS. 3 and 5, first connection opening 17a is shown as a connection opening between second fluid chamber 13b and second fluid channel 12b and second connection opening 17b is shown as a connection opening between second fluid channel 12b and third fluid chamber 13c. However, the general height structure of the connection openings relative to the fluid chambers 13 and the fluid channels 12 is the same for all sets of neighboring, connected fluid chambers 13 and the connecting fluid channels 12.

As shown in FIGS. 3 and 5, the inner height of the in each case preceding fluid chamber 13a-13d with relatively great height corresponds to the height of the corresponding connection opening 17a, and the inner height of the fluid chamber 13a-13d which is the next one in the series corresponds to the height of the corresponding connection opening 17b. More specifically, in the illustrative embodiment shown in FIGS. 3 and 5, the inner height H3 of the preceding second fluid chamber 13b with corresponds to the height of the corresponding connection opening 17a connecting the second fluid chamber 13b to the second fluid channel 12b, and the inner height H4 of the third fluid chamber 13c, which is the next one in the series, corresponds to the height of the corresponding connection opening 17b connecting second fluid channel 12b to the third fluid chamber 13c.

The fluid channels 12a-12c, which are closed or enclosed on all sides in vertical cross section, are each downwardly closed by bottom walls portions or bottom wall 18 and upwardly closed by top wall portions or top walls 19. Here, the bottom wall portions or bottom walls 18, just like the bottom walls 15 of the fluid chambers 13a-13d, are formed by the base plate 16. The top wall portions or top walls 19 of the fluid channels 12a-12c integrally adjoin the top walls 14 of the fluid chambers 13a-13d. The use of the term top wall portion or top wall 19 is used generally as for a fluid channel 12 having distinct walls (for example a top wall, two side walls, and a bottom wall), the term top wall would be more appropriate, while for a fluid channel 12 having a tubular shape, the term top wall portion would be more appropriate. In either case, the top wall portion or top wall 19 is the portion of the fluid channel 12 located vertically upwards, the bottom wall portion or bottom wall 18 is the portion of the fluid channel 12 located vertically downwards, and the side wall portions or side wall 28 is the portion of the fluid channel 12 located between and connecting the top wall portion or top wall 14 with the bottom wall portion or bottom wall 18 so as to form the unified closed or enclosed fluid channel 12.

The top wall portions or top walls 19 of the fluid channels 12a-12c extend so as to be inclined with respect to the horizontal. Here, for each pair of fluid chambers 13a, 13b; 13b, 13c; and 13c, 13d, which are successive in the series, it is the case that the inner height H of the respective fluid channel 12a, 12b, 12c, that is to say the spacing of the respective downwardly facing inner side of the top wall portion or top wall 19 to the respective upwardly facing inner side of the bottom wall portion or bottom wall 18, is greater (higher) in the region in which the respective fluid channel 12a, 12b, 12c adjoins the connection opening 17a to the preceding fluid chamber 13a, 13b, 13c, than at the other end of the respective fluid channel 12a, 12b, 12c, at which the fluid channel 12a, 12b, 12c adjoins the connection opening 17b to the succeeding fluid chamber 13b, 13c, 13d. This cascading inclined structure in the direction of flow X of the sample fluid can be seen in more detail in FIG. 6.

Between the two connection openings 17a, 17b, the inner side of the top wall portion or top wall 19 extends along the respective fluid channel 12a-12c at least sectionally in an obliquely downwardly inclined manner in the direction of flow X of the sample fluid, with the result that the corresponding fluid channel 12a-12c decreases continuously in height in this direction or increases in height the opposite direction. In the present case, the respective fluid channel 12a-12c, apart from a region in which a bubble trap 24 (described in more detail later) is arranged, widens continuously and constantly in the direction of flow X of the sample fluid substantially over its entire respective length.

It is expressly within the scope of the invention that the respective fluid channel 12a-12c widens in the direction of flow X of the sample fluid only in a respective sub-section of the respective fluid channel 12a-12c (that is to say not along the entire length of the fluid channel 12a-12c) or in multiple (shorter) sub-sections of the respective fluid channel 12a-12c. In this case, it is not necessary for the respective fluid channel 12a-12c to widen constantly, but rather variable or non-constant widening are conceivable. Moreover, discontinuities can also occur in the widening.

Each measurement chamber system 11 moreover has an inlet chamber 20, which is connected via an inlet fluid channel 21 to the first fluid chamber 13a with greatest inner height.

Furthermore, each measurement chamber system 11 has an outlet chamber 23, which is connected via an outlet fluid channel 22 to the last fluid chamber 13 with smallest inner height, which is the fourth fluid chamber 31d in the illustrative embodiments shown in the figures, which is last in the series of the fluid chambers 13a-13d.

Each measurement chamber system 11 can be filled via the inlet chamber 20 with sample liquid, which then flows via the inlet fluid channel 21 into the first fluid chamber 13a and via the further fluid channels 12a, 12b, 12c into the second, third, and fourth fluid chambers 13b, 13c, 13d, respectively, which follow in the series, and finally via the outlet fluid channel 22 into the outlet chamber 23.

With a corresponding filling, the individual fluid chambers 13a-13d are filled completely, that is to say until the height of the fluid level corresponds to the inner height H of each of the individual fluid chambers 13a-13d.

Owing to the different inner heights H of the different fluid chambers 13a-13d, for light beams which are emitted vertically into the fluid chambers 13a-13d from above through the transparent top walls 14 during photometric measurements, different optical path lengths are established in the respective sample liquid of the respective fluid chamber 13a-13d.

Using the Lambert-Beer law, the concentration of the molecular concentration contained in the sample fluid within the measurement chamber systems 11 can then be inferred by analysis of the absorption values of the sample liquid, which absorption values differ owing to the different path lengths.

It is possible, in particular during the filling of the measurement chamber systems 11, for turbulent flows to be formed, which promote the escape of air bubbles from the respective sample liquid, which air bubbles can in turn interfere in particular with optical or photometric measurements.

One provision of the invention is the minimization of such flows. For this purpose, the fluid channels 12a-12c, in each case in terms of their width or breadth W, are formed to widen from the fluid chamber 13a-13d with greater inner height, which is the preceding one in the series of the fluid chambers 13a-13d, to the next fluid chamber 13a-13d or to narrow in the reverse direction, as shown in the plan view in FIG. 2. In this way, pressure differences in the measurement chamber system 11 are reduced.

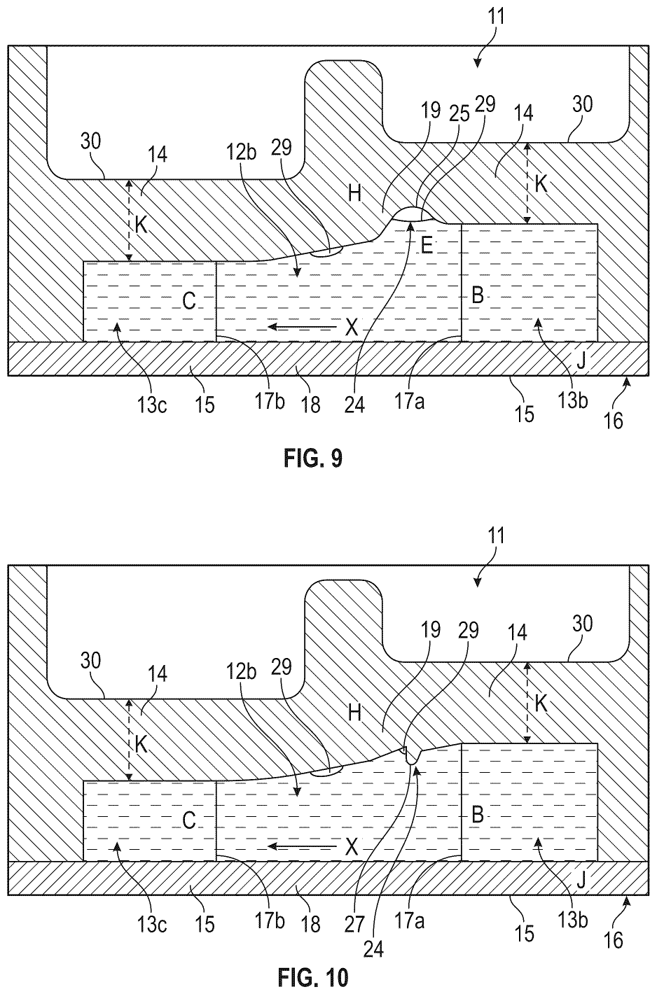

According to a further particular feature, provision is made for the trapping of air bubbles 29 (see FIGS. 9-10), should these be formed and situated in the respective fluid channel 12a-12c. For this purpose, bubble traps 24 are respectively positioned in the fluid channels 12a-12c. In the present exemplary embodiment, said bubble traps 24 are recesses 25 which are arranged in the respective top wall portion or top wall 19 and which face downward toward the interior of the respective fluid channel 12a-12c.

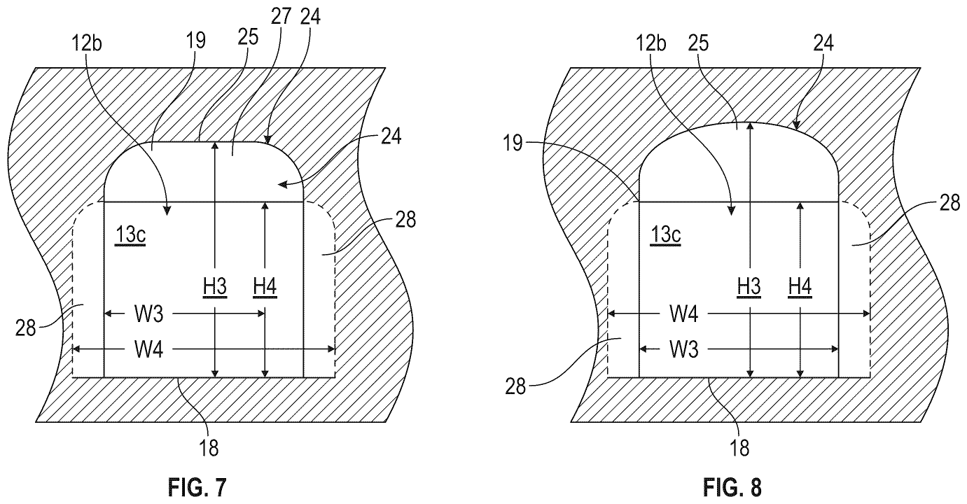

In the present exemplary embodiment, said recesses 25 extend over the entire width or breadth of the respective top wall portion or top wall 19, as can be seen in FIGS. 2 and 8.

Moreover, in the present case, the recess 25 is in each case arranged such that the highest point of the recess 25 in the top wall portion or top wall 19 is above the maximum inner height of the respective fluid channel 12a-12c along the fluid channel 12a-12c.

It is also the case that, in the present case, the height of the recess 25 at the highest point is in each case greater than the height of the connection opening 17a, which adjoins the respective fluid chamber 13 of greater inner height of the fluid chambers 13a-13d of the respective pair of fluid chambers 13a, 13b; 13b, 13c; 13c, 13d between which the respective fluid channel 12a-12c extends.

Finally, the height of said recess 25 at the highest point is also greater than the inner height of the in each case other fluid chamber 13a-13d with smaller inner height of the respective pair of fluid chambers 13a, 13b; 13b, 13c; 13c, 13d.

Insofar as, for example during or after the filling of the measurement chamber system 11 with the sample liquid, air bubbles 29 exiting the fluid chamber 13a-13d with smaller inner height migrate into the fluid channel 12a-12c and then, owing to the inclined or obliquely extending inner side of the top wall portion or top wall 19 of the respective fluid channel 12a-12c, migrate on said inner side of the top wall portion or top wall 19 toward the other fluid chamber 13a-13d, with greater inner height, of the respective pair of fluid chambers 13a, 13b; 13b, 13c; 13c, 13d, said air bubbles 29 are trapped in the recess 25 of the bubble trap 24 on their path along the inner side of the top wall portion or top wall 19. Accordingly, said air bubbles 29 are then unable to enter the respective fluid chamber 13a-13d with greater inner height and, there, distort the measurement results.

As an alternative to such recesses 25 in the top wall portion or top wall 19, it is also possible for example for provision to be made of downwardly directed projections or webs 27, as shown in FIGS. 5, 7, and 10, which are attached to the top wall portion or top wall 19 (in particular the inner side thereof), in particular are integrally formed thereon, and can in a similar manner stop air bubbles 29 continuing along their path.

FIG. 6 shows a cross section along line C-C of FIG. 2 and represents an elongated straightened side view of an exemplary embodiment of a single measurement system 11. In this view, the fluid chambers 13 can be seen as decreasing in height H along the direction of flow X of the fluid sample. Namely, the height H2 of the first fluid chamber 13a is greater than the height H3 of the second fluid chamber 13b, which in turn is greater than the height H4 of the third fluid chamber 13c, which in turn in greater than the height H5 of the fourth fluid chamber 13d. Also in this view, the fluid channels 12 can be seen as decreasing in height along the direction of flow X of the sample fluid. Namely, the first fluid channel 12a decreases in height between the first fluid chamber 13a and the second fluid chamber 13b, the second fluid channel 12b decreases in height between the second fluid chamber 13b and the third fluid chamber 13c, and the third fluid channel 12c decreases in height between the third fluid chamber 13c and the fourth fluid chamber 13d.

FIG. 6 also illustrates that the bottom wall 15 of each fluid chamber 13a-13d is formed by the common base plate 16. As also can be seen in FIGS. 7-10, the base plate 16 of the microtiter plate 10 forms a plate bottom wall for the entire microtiter plate 10, with a top surface of the base plate 16 forming the interior bottom wall 15 of the fluid chambers 13 and the bottom wall portions or bottom walls 18 of the fluid channels 12. Similarly, FIG. 6 also illustrates that the top walls 14 of the individual fluid chambers 13a-13d are formed as different areas of a common plate top wall 30 of the microtiter plate 10 and are correspondingly connected to one another integrally so as to merge into one another.

A further particular feature of the invention illustrated best in FIGS. 6 and 9-10 is that the top walls 14 (with their outer side adjacent to the surroundings) of the respective fluid chambers 13a-13d each have the same thickness K in order to configure in an identical manner the optical path lengths through said top walls 14, that is to say within the respective top wall 14, for emitted detection light. In this way, it is possible, if appropriate, to dispense with calibration measurements.

Finally, as also illustrated best in FIGS. 4 and 6, a further particular feature is the design of the inlet chamber 20 and the outlet chamber 23. Both the upwardly open inlet chamber 20 and the upwardly open outlet chamber 23 are in each case designed such that the lateral walls 26 thereof or the interior, enclosed by the lateral walls 26, thereof slightly widen(s) upwardly, specifically perpendicular to the bottom plate 16. This allows different tips and cannulas of a very wide variety of diameters to be placed on the inlet chamber 20 or the outlet chamber 23, with the result that simple filling and emptying of the system is possible.

The fact that, in the present case, the inlet chamber 20 and the outlet chamber 23, respectively, are also of substantially identical design means that, theoretically, it would also be possible for the respective measurement system 11 to be filled in the manner which is the reverse of the designated manner, specifically in that, instead of the inlet chamber 20, the respective outlet chamber 23 is filled with the sample liquid, and, at a later stage, the respective inlet chamber 20 is used for emptying the measurement chamber system 11.

FIG. 7 shows a cross section along line F-F of FIG. 3 showing a structure of a bubble trap 24 in the form of a projection or web 27. In FIG. 7, the bubble trap 24 is shown as a projection or web 27 that is arranged in the respective top wall portion or top wall 19 of the fluid channel 12b and which faces downward toward the interior of the respective fluid channel 12b. Preferably, the downwardly directed projections or webs 27 that are attached to the top wall portion or top wall 19 (in particular the inner side thereof), in particular are integrally formed on the top wall portion or top wall 19, and can in a similar manner trap and stop air bubbles 29 continuing along their path along the top wall portion or top wall 19.

FIG. 8 shows a cross section along line G-G of FIG. 5 showing a structure of a bubble trap 24 in the form of a recess 25. In FIG. 8, the bubble trap 24 is shown as a recess 25 that is arranged in the respective top wall portion or top wall 19 of the fluid channel 12b and which faces downward toward the interior of the respective fluid channel 12b. The height of the recess 25 at the highest point is preferably greater than the height of the connection opening 17a (see FIGS. 9-10 for more detail), which adjoins the respective fluid chamber 13 of greater inner height of the fluid chambers 13a-13d of the respective pair of fluid chambers 13a, 13b; 13b, 13c; 13c, 13d between which the respective fluid channel 12a-12c extends. Also, the height of the recess 25 at the highest point preferably is greater than the inner height of the in each case other fluid chamber 13a-13d with smaller inner height of the respective pair of fluid chambers 13a, 13b; 13b, 13c; 13c, 13d. Preferably, the downwardly directed recess 25 in the top wall portion or top wall 19 (in particular the inner side thereof), in particular are integrally formed in the top wall portion or top wall 19, and can in a similar manner trap and stop air bubbles 29 continuing along their path along the top wall portion or top wall 19.

FIGS. 7 and 8 also illustratively show the decreasing height H and increasing width W of the second fluid channel 12b, as illustrative of all of the fluid channels 12. Specifically, the second fluid channel 12b decreases in height from height H3 to height H4 and increases in width from width W3 to width W4 in the direction of flow X of the sample fluid (into the page). In FIG. 8, height H3 is shown as the height of the second fluid channel 12b including the recess 25.

FIG. 9 shows an alternate view of FIG. 4 showing an operation of a bubble trap 24 in the form of a recess 25. In this view, the fluid chambers 13b, 13c and the second fluid channel 12b are shown as filled by a sample fluid as indicated by the horizontal dashed lines. Air bubbles 29 that may form in the sample fluid rise to the top of the sample fluid and up against the top wall portion or top wall 19 of the second fluid channel 12b. Air bubbles 29 also can arise in the fluid chamber 13c and travel out of the third fluid chamber 13c into the second fluid channel 12b. Any such air bubbles 29 will travel upwards along the slope of the top wall portion or top wall 19 of the second fluid channel 12b and encounter and be trapped in the recess 25.

FIG. 10 shows an alternate view of FIG. 5 showing an operation of a bubble trap 24 in the form of a projection or web 27. In this view, the fluid chambers 13b, 13c and the second fluid channel 12b are shown as filled by a sample fluid as indicated by the horizontal dashed lines. Air bubbles 29 that may form in the sample fluid rise to the top of the sample fluid and up against the top wall portion or top wall 19 of the second fluid channel 12b. Air bubbles 29 also can arise in the fluid chamber 13c and travel out of the third fluid chamber 13c into the second fluid channel 12b. Any such air bubbles 29 will travel upwards along the slope of the top wall portion or top wall 19 of the second fluid channel 12b and encounter and be trapped in at the projection or web 27.

Thus, insofar as, for example during or after the filling of the measurement chamber system 11 with the sample liquid, air bubbles 29 exiting a fluid chamber 13 with smaller inner height migrate into the fluid channel 12 and then, owing to the inclined or obliquely extending inner side of the top wall portion or top wall 19 of the respective fluid channel 12, migrate on said inner side of the top wall portion or top wall 19 toward the other fluid chamber 13, with greater inner height, of the respective pair of fluid chambers 13a, 13b; 13b, 13c; 13c, 13d, said air bubbles 29 are trapped in the recess 25 or projection or web 27 of the bubble trap 24 on their path along the inner side of the top wall portion or top wall 19. Accordingly, the air bubbles 29 are then unable to enter the respective previous fluid chamber 13 with greater inner height and, there, distort the measurement results.

The foregoing detailed description of the preferred embodiments and the appended figures have been presented only for illustrative and descriptive purposes. They are not intended to be exhaustive and are not intended to limit the scope and spirit of the invention. The embodiments were selected and described to best explain the principles of the invention and its practical applications. One skilled in the art will recognize that many variations can be made to the invention disclosed in this specification without departing from the scope and spirit of the invention.

### LIST OF REFERENCE SIGNS

10 Microtiter plate
11 Measurement system
12a First fluid channel
12b Second fluid channel
12c Third fluid channel
13a First fluid chamber
13b Second fluid chamber
13c Third fluid chamber
13d Fourth fluid chamber
14 Top wall
15 Bottom wall
16 Base plate
17a First connection opening
17b Second connection opening
18 Bottom wall portion or bottom wall
19 Top wall portion or top wall
20 Inlet chamber
21 Inlet fluid channel
22 Outlet fluid channel
23 Outlet chamber
24 Bubble trap
25 Recess
26 Lateral wall
27 Projection or web
28 Side wall portion or side wall
29 Air bubble
30 Plate top wall
H Height
W Width or breadth

What is claimed is:

1. A microtiter plate having multiple measurement chamber systems, each of the multiple measurement chamber systems comprising:
a first fluid chamber and a second fluid chamber in which measurement of a sample fluid occurs;
a first fluid channel that connects the first fluid chamber to the second fluid chamber and that, in vertical cross section perpendicular to an axis of the first fluid channel, is closed on all sides by at least one wall, the wall comprising a top wall portion and a bottom wall portion connected by side wall portions extending between the top wall portion and the bottom wall portion; and
a base plate comprising a bottom wall, an upper surface of which forms a bottom wall of the fluid chambers and the bottom wall portion of the first fluid channel,
wherein the first fluid channel comprises an interior through which the sample fluid being tested in the microtiter plate flows between the first fluid chamber and the second fluid chamber, the interior of the first fluid channel being connected at one end via a first connection opening to the first fluid chamber and at another end via a second connection opening to the second fluid chamber;
wherein the first fluid channel further comprises a bubble trap, by way of which the movement of gas bubbles that may be in the fluid being tested in the microtiter plate and which gas bubbles move along the top wall portion of the first fluid channel between the connection openings can be stopped, the bubble trap being located in the top wall portion of the first fluid channel,
wherein the bubble trap comprises at least one of (i) a downwardly facing recess in the top wall portion of the first fluid channel that is open toward the fluid channel interior, and (ii) a downwardly directed projection or web that is formed on the top wall portion of the first fluid channel.

2. The microtiter plate as claimed in claim 1, further comprising an inlet chamber for each of the measurement chamber systems for providing a sample fluid to each of the measurement chamber systems and an outlet chamber for each of the measurement chamber systems for removing the sample fluid from each of the measurement chamber systems.

3. The microtiter plate as claimed in claim 1, wherein if the bubble trap comprises the recess, the recess, in cross section, extends over the entire width or breadth of the top wall portion of the first fluid channel.

4. The microtiter plate as claimed in claim 1, wherein if the bubble trap comprises a projection, the projection covers a portion of an inner surface of the top wall portion of the first fluid channel.

5. The microtiter plate as claimed in claim 4, wherein the projection sealingly covers the portion of the inner surface of the top wall portion of the first fluid channel and to side wall portions of the first fluid channel, the side wall portions of the first fluid channel extending between the connection openings of the first fluid channel, so that, to the sides of and above the projection, no gas bubbles are able to move past the projection or web.

6. The microtiter plate as claimed in claim 1, wherein the first fluid channel decreases in height and increases in width in a direction of flow of the sample fluid from the first fluid chamber to the second fluid chamber at least in a first section of the first fluid channel such that, in said first section of the first fluid channel, an inner side of the top wall portion of the first fluid channel extends so as to be inclined to the horizontal.

7. The microtiter plate as claimed in claim 2, wherein if the bubble trap comprises the recess, a height of the recess of the bubble trap at a highest point of the recess is at least one of:
greater than a maximum height of the first fluid channel;
greater than a height of the first connection opening which connects the first fluid channel to the fluid chamber in the direction from the inlet chambers to the outlet chambers; and
greater than a height of the first fluid chamber in the direction from the inlet chambers to the outlet chambers.

8. The microtiter plate as claimed in claim 1, further comprising a plurality of fluid channels that connect a plurality of fluid chambers in succession in a fluid flow direction of the sample fluid, wherein each of the fluid channels comprises a bubble trap.

9. The microtiter plate as claimed in claim 1, wherein the first fluid channel is tubular in structure and the top wall portion is a portion of the tubular structure corresponding to a top of the tubular structure, the bottom wall portion is a portion of the tubular structure corresponding to a bottom of the tubular structure, and the side wall portions are portions of the tubular structure corresponding to sides of the tubular structure.

10. The microtiter plate as claimed in claim 1, wherein the top wall portion is a top wall corresponding to a top of the first fluid channel, the bottom wall portion is a bottom wall located directly below the top wall and corresponding to a bottom of the first fluid channel, and the side wall portions are side walls connecting the top wall to the bottom wall and corresponding to sides of the first fluid channel.

11. The microtiter plate as claimed in claim 2, wherein the inlet chamber is connected to the first fluid chamber by an inlet fluid channels, and via which the sample fluid is supplied to the measurement chamber system.

12. The microtiter plate as claimed in claim 2, wherein the outlet chamber is connected to the second fluid chamber in the direction from the inlet chamber to the outlet chamber by an outlet fluid channel, and via which the sample fluid is removed from the measurement chamber system.

13. The microtiter plate as claimed in claim 1, wherein the microtiter plate has at least two fluid chambers, each of which is upwardly closed by a the top wall, wherein an inner height of each successive fluid chamber in a direction of flow of the sample fluid is less than the inner height of a previous fluid chamber, wherein each of the successive fluid chambers is connected to the previous fluid chamber by a fluid channel which decreases in height and increase in width in the direction of flow of the sample fluid from the previous fluid chamber to the successive fluid chamber in at least one section of the fluid channel.

14. The microtiter plate as claimed in claim 1, wherein the top walls of the fluid chambers consist of material transparent to visible light, and the top walls of the fluid chambers each have the same thickness as each other.

15. The microtiter plate as claimed in claim 13, wherein the top walls of the fluid chambers each have an inner side that faces the interior of the respective one of the fluid chambers, and an outer side that faces outwards from the microtiter plate, wherein the top wall has a consistent thickness between the inner side and the outer side along the entire length of the top wall.

16. The microtiter plate as claimed in claim 15, wherein the inner sides of the top walls of the fluid chambers, facing the interior of the respective fluid chambers, and/or the outer side of the top walls of the fluid chambers, extend parallel to the base plate of the microtiter plate or parallel to an outer side of the base plate.
